(19) United States
(12) Patent Application Publication
(10) Pub. No.: US 2001/0026449 A1
(43) Pub. Date: Oct. 4, 2001

(54) Status indicator light

(76) Inventors: Ronald E. Wiggerman, McHenry, IL (US); Rudolph R. Guzik, Frankfort, IL (US); Allan E. Boleslawski, Bear, DE (US)

Correspondence Address: GARDNER, CARTON & DOUGLAS, 321 N. CLARK STREET, SUITE 3400, CHICAGO, IL, 60610, US

(21) Appl. No.: 09/777,399

(22) Filed: Feb. 6, 2001

Related U.S. Application Data
(60) Provisional application No. 60/180,546, filed on Feb. 7, 2000.

(51) Int. Cl. F21V 1/00

(52) U.S. Cl. 362/276; 362/477

(57) ABSTRACT

Disclosed is a boat light having a status indicator. The status indicator activates when the boat light is illuminated, and the status indicator may be viewed by the operator of the boat under any lighting conditions. The boat light comprises a housing, a lens, an illumination source emitting light through the lens; and a status indicator that emits light when the illumination source emits light.

### RELATED APPLICATION

This application claims the benefit of U.S. Provisional Application No. 60/180,546, filed on Feb. 7, 2000.

### FIELD OF THE INVENTION

The invention relates generally to lighting for marine vessels and, more particularly, to a boat light with an indicator that indicates to a boater whether the boating light is operating.

### BACKGROUND OF THE INVENTION

Regulations require motor boats to have multiple navigational and identifying lights. Such lights include bow lights, which are placed at the bow of a boat, as well as running lights, which are bright lights that can be seen for up to a distance of a mile or more.

Bow lights, for example, serve not only as marine vessel identifiers, but also as waterway traffic control devices. As traffic control devices, bow lights signal to a boat's driver whether he has the right of way or must yield to another boat in a given circumstance. For instance, if a first boat and a second boat are approaching each other from an angle where the driver of the first boat views the second boat off of his starboard side, the operator of the first boat number one will view a red light on the second boat and the driver of the second boat will view a green light on the first boat. Thus, the driver of the first boat knows that since he has seen a red light, he must yield the right of way to the second boat in this situation. Conversely, the driver of the second boat, seeing a green light on the first boat, knows that he has the right of way in this situation. The bow lights are typically installed on the bow's deck surface and consist of a two-toned lens (one-half green on the starboard side and one-half red on the port side) covering a single light source. Alternatively, bow lights can be mounted on the hull sidewalls near the bow using single tone lens (green on the starboard side and red on the port side) covering separate light sources.

Bow lights are typically positioned to cast light in a direction generally forward from the light source so they are visible to boats approaching each other. Depending on the configuration of the boat hull, it can thus be difficult for a boater to view his own bow lights to determine if the lights are illuminated. Also, it is difficult under some lighting conditions with partial light (such as dusk or dawn or in heavily overcast or stormy conditions) to determine if the bow lights are operational.

Running lights, for example, are lights commonly used on fishing vessels that signal the presence of the vessel to other boaters. Running lights are bright, and can substantially diminish the night sight of the operator. These lights are often situated such that the operator cannot easily see the bow of the boat and the area of the forward portion of the boat immediately surrounding the bow, including the bow lights.

Currently, there are no known methods to quickly and easily indicate that a boating light is operational. A boater has to personally inspect each light individually and often by directly facing the light, to know if it is working. Often, the operator will leave port during the daylight, only to discover at night that one or more of the boat lights are non-functional. Alternatively, the operator must perform a time consuming and inconvenient manual check of each of the numerous lights on a boat prior to leaving port. As the boat lights are critical for safe operation of the boat, so are the frequent manual checks an operator must make in order to ensure that all the lights on the boat are in working condition. This manual inspection of each light can be difficult because of the location of the lights and direction in which the lights are directed.

There is need, therefore, for a boat light with a status indicator that quickly and easily permits a boater to know if boat lights, such as bow lights, are functional. There is a further need for a boat light with a status indicator that is effective in daylight, situations of partial light, or situations where the operator's ability to directly view the boat light may be limited, or where the boat light source may be difficult to see due to positioning of the light, such as away from the operator.

### SUMMARY OF THE INVENTION

It is an object of the invention to provide a boat light with a status indicator, whereby a boater may quickly and easily monitor the working status of a boat light, for example, a bow light or navigational light, by viewing the status indicator. It is another object of the invention to provide a status indicator for indicating the illumination status of a boat light under conditions where it is difficult to discern whether the boat light is illuminated or not.

The above and additional objects are realized in the present invention, which provides a boat light with a status indicator that permits the operator of a boat to determine whether a boat light is on without viewing the boat light directly. The boat light of the invention comprises a housing, an illumination source, a lens, and a status indicator, whereby the status indicator is integrated with the light and turns on when the connected boat light is illuminated. Thus, little, if any, additional wiring is needed for the status indicator. The housing surrounds both the illumination source and the status indicator.

### BRIEF DESCRIPTION OF THE DRAWINGS

Other objects and advantages of the invention will be apparent from the following detailed description and the accompanying drawings, in which:

FIG. 1 is an exploded schematic view illustrating the components of one embodiment of the status indicator light of the invention; and

FIG. 2 is a cutaway view illustrating one embodiment of the light with status indicator of the invention.

### DESCRIPTION OF THE PREFERRED EMBODIMENT

While the invention is susceptible to various modifications and alternative forms, certain preferred embodiments are shown by way or example in the drawings and will herein be described in detail. It should be understood, however, that it is not intended to limit the invention to the particular forms described, but to the contrary, the invention is intended to cover all modifications and alternatives falling within the spirit and scope of the invention as defined by the appended claims. For instance, the invention illustrated herein is also suitable outside of the marine field where similar drawbacks are sought to be overcome, but the marine field is particularly suitable to the invention.

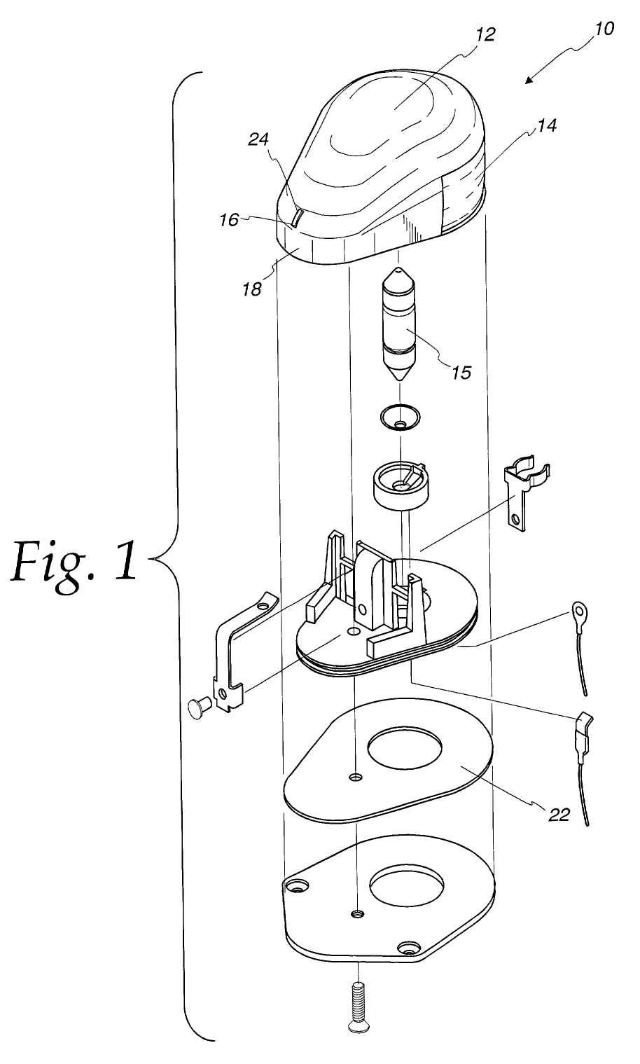

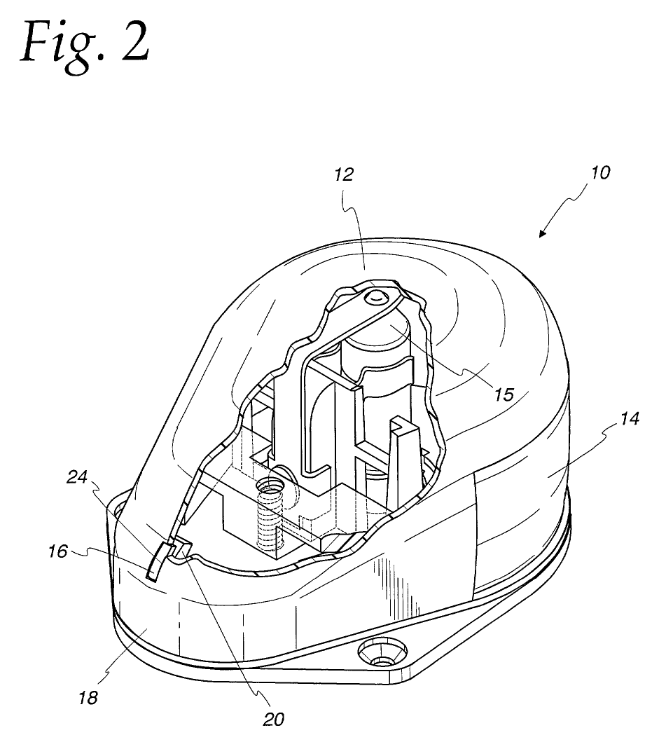

The present invention relates to a status indicator for a boat light, and to a boat light having such an indicator as depicted in FIGS. 1 and 2. The boat light 10 of the present invention can be a navigation light or any other type of light used on a boat or other marine vehicle. The design of such lights is well known in the art, and a large variety of boat lights are currently available and may be adapted to utilize the status indicator of the present invention.

The boat light 10 of the invention includes a housing 12 and at least one lens 14. The housing 12 and the lens 14 are generally made waterproof and serve to protect the inner electrical components of the light from exposure to water. Many suitable housing and lens materials are commercially available, and any material that is sufficiently durable and waterproof will be suitable for use in the invention. Housing materials include but are not limited to metals such as but not limited to steel, and many plastics and polymer compounds, plexiglass, and some glasses, among other materials. Optionally, the housing may include one or more seals or gaskets 22, that may aid in waterproofing the housing. Lens materials include any of the materials listed above that are sufficiently transparent for use as the lens. The lens 14 must be sufficiently transparent to allow light from a boat illumination source 15 to be emitted through the lens, to an extent appropriate for the purpose of the boat light 10. The housing further includes an opening 24 through which a status indicator may be viewed.

A boat illumination source 15 such as, but not limited to, a light bulb or any other suitable illumination source is positioned within the housing 12 so that light is emitted through the lens 14 in a known manner appropriate for the purpose of the boat light 11, for example, a bow light or a running light. The present invention also includes a status indicator 16 on the rear side 18 of the boat light 10, oriented in a direction approximately facing the boat operator. The rear side 18 is on the approximate opposite side of the housing 12 from the lens 14, and it may encompass, for example, an entire semicircle if the light 10 is generally circular in its perimeter shape, as shown in FIGS. 1 and 2. The rear side 18 is the side that is visible to and approximately faces the location of the operator during operation of the boat.

In one embodiment of the invention as depicted in FIG. 1, the status of the light is indicated by reflected light from the illumination source 15 shining through the opening 24 of the status indicator 16. In this embodiment, the opening 24 is sealed with a transparent or translucent material 20 (as shown in FIG. 2) that may optionally be colored. Suitable materials for sealing the opening 24 include glass, plastic and the like.

In yet another embodiment of the invention, the status indicator 16 of the invention optionally includes an indicator light separate from the boat illumination source 15 such as a light emitting diode (LED), halogen bulb or any other suitable light source (a wide variety of which are commercially available and known to those skilled in the art). The indicator light source may be connected to the circuit of the boat illumination source 15 in a series arrangement. Examples of a suitable indicator light include a light emitting diode (LED), a small halogen bulb, or other relatively small light bulb. The light source may emit colored light, such as but not limited to red or green light, or it may emit “white” light.

In either embodiment, the light from the boat illumination source 15 or the indicator light is bright enough for the operator to view from the operating location of the boat but not so bright that it disrupts the operation of the boat. If the boat illumination source 15 turns on correctly, the status indicator 16 reflects the activated condition of the boat illumination source 15 by emitting light. The light emitted from the status indicator 16 may be viewed through opening 24 in the housing 12. If the boat light is not operational, the light source will not illuminate. The operator will then see that the illumination source 15 or boat light 10 must be inspected and repaired or replaced.

What is claimed is:

1. A light mounted on a boat comprising:
a housing;
a lens;
a light bulb positioned to emit light through the lens; and
a means mounted on the housing to indicate when the light bulb emits light through the lens.

2. A light for a boat comprising:
a housing having a status indicator opening;
a lens;
an illumination source positioned to emit light through the lens; and
a status indicator that activates when the illumination source emits light.

3. The light of claim 2 wherein the status indicator and the illumination source are linked in series in an electrical circuit.

4. The light of claim 2 wherein the housing has a rear side and wherein the status indicator opening is located in the rear side of the housing and approximately opposite the illumination source.

5. The status indicator of claim 2 wherein the status indicator is emitted light.

6. The status indicator of claim 2 wherein light from the illumination source is emitted through the status indicator.

7. The light of claim 2 wherein the light is a navigation light.

8. The status indicator of claim 5 wherein the light source is a light emitting diode.

9. The status indicator of claim 5 wherein the emitted light is visible in daylight.

10. The light of claim 7 wherein the navigation light is a bow light.

11. The status indicator of claim 10 wherein the emitted light is colored.
